(19) United States
(12) Patent Application Publication
(10) Pub. No.: US 2009/0310161 A1
(43) Pub. Date: Dec. 17, 2009

(54) IMAGE PROCESSING APPARATUS AND METHOD THEREOF

(75) Inventor: Naoto Kawamura, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/482,534

(22) Filed: Jun. 11, 2009

(30) Foreign Application Priority Data
Jun. 17, 2008 (JP) 2008-158556

(51) Int. Cl. G06F 15/00

(52) U.S. Cl. 358/1.9

(57) ABSTRACT

First data, which is calculated from quantization errors of adjacent pixels of a pixel of interest in accordance with an error diffusion matrix, and second data, which is calculated from quantization results of the adjacent pixels in accordance with a reference pixel matrix and a gain coefficient, are added to color data of the pixel of interest. The color data of the pixel of interest, to which the first and second data are added, is quantized, and a quantization error of the pixel of interest is calculated from the quantization result. Different combinations of reference pixel matrices and gain coefficients are respectively used for a plurality of color component data.

### BACKGROUND OF THE INVENTION

1. Field of the Invention

The present invention relates to image processing and, more particularly, to error diffusion processing of image data.

2. Description of the Related Art

In digital printing, an error diffusion method is used in many image output apparatuses as a binarization method which is free from generation of moiré and has excellent tone reproducibility. The error diffusion method, which produces less textured structures than an ordered dither method and density pattern method and locally preserves tonality, provides satisfactorily high image quality for characters, line-arts, and tonal images.

Furthermore, an output-feedback type error diffusion method exhibits a so-called green-noise characteristic in which the spectra of high- and low-frequency regions are cut down by clustering halftone dots to shift a main spatial frequency to the low-frequency region. Such error diffusion method is also called error diffusion processing based on a green-noise method, and is applicable to electrophotographic digital printers as a stable FM modulation method. An FM screen that adopts such FM modulation method has the following features compared to an AM screen.
1. No beat (moiré) is generated with an image having periodicity.
2. No beat color (moiré) is generated between different colors.
3. A color reproductive area is broadened.
4. The FM screen is robust against misregistration.

Since the FM screen of the error diffusion processing based on the green-noise method does not generate any moiré of a color screen (called a Rosetta pattern) generated by an AM screen, it is expected as a method of generating high-quality color halftone data.

However, upon executing excessive processing such as strong feedback to attain distinguished clustering using the error diffusion processing based on the green-noise method, periodic anisotropic textured structures locally appear, thus considerably deteriorating image quality, and generating local moiré.

A “local moiré phenomenon” will be described below with reference to FIGS. 1 to 3C.

FIG. 1 shows a state in which a feedback gain coefficient h of the green-noise method is changed upon applying error diffusion processing to tonal data (0 to 255). An uppermost part of FIG. 1 shows the processing result when the gain coefficient h=0, that is, that of the error diffusion method itself. As the gain coefficient h increases, clustering progresses, dots become coarser, and the peak of the spatial frequency shifts to a low-frequency region. As the gain coefficient h further increases, dot patterns having parallel periodicity appear in a middle density range (corresponding to tonal values=100 to 140) bounded by a bold frame, as shown in the lowermost part in FIG. 1. Local moiré is generated by such periodicity of patterns, thus generating color moiré.

FIGS. 2A to 2D are views showing the application results of the error diffusion processing based on the green-noise method to cyan and magenta in a middle density range (a tonal value=120). As shown in FIGS. 2A and 2B, dot connections occur, and patterns locally having periodicity appear. A color output (FIG. 2C) obtained by superimposing these colors causes color moiré. FIG. 2D expresses superimposition using an identical color (black), and generation of color moiré is obviously understood. Note that the gain coefficient h and the like will be described later.

On the other hand, FIGS. 3A to 3C are views showing the application results of the error diffusion processing based on the green-noise method to cyan and magenta in a highlight region (a tonal value=192). As shown in FIGS. 3A and 3B, since no dot connections occur, patterns locally having periodicity do not appear. Therefore, a color output (FIG. 3C) obtained by superimposing these colors hardly causes color moiré.

As described above, with the error diffusion processing based on the green-noise method, dot connections occur and color moiré is readily generated in a middle density range of an image. As another problem, color heterogeneity is caused by adjacent arrangements and superimpositions of dots in a highlight region of an image.

FIG. 4 is a view showing a color output obtained by independently processing three color components cyan, magenta, and yellow of a certain color, and compositing the processing results.

As shown in FIG. 4, a color which is originally reproduced as one color suffers different color heterogeneities in a part where color dots are superimposed, and a part where they are adjacently arranged. This is because the superimposition of color dots is reproduced by subtractive mixture, the adjacent arrangement of color dots is reproduced by additive mixture, and color mixture method differences appear as color heterogeneities. This problem is also posed in a shadow region. That is, in the shadow region, white dots (each having the blackened peripheral part and hollow central part) are superimposed or adjacently arranged, thus causing color heterogeneities as in the highlight region.

As described above, the error diffusion processing based on the green-noise method causes color moiré in a middle density range due to distinguished clustering, and causes color heterogeneity in highlight and shadow regions of an image, thus considerably impairing image quality of a color output.

### SUMMARY OF THE INVENTION

In one aspect, a method of quantizing color data having a plurality of color component data, comprises the steps of: adding, to color data of a pixel of interest, first data which is calculated from quantization errors of adjacent pixels of the pixel of interest in accordance with an error diffusion matrix; adding, to the color data of the pixel of interest, second data which is calculated from quantization results of the adjacent pixels in accordance with a reference pixel matrix and a gain coefficient; quantizing the color data of the pixel of interest, to which the first and second data are added; and calculating a quantization error of the pixel of interest from the quantization result, wherein different combinations of reference pixel matrices and gain coefficients are respectively used for the plurality of color component data.

According to the aspect, generation of color moiré in the error diffusion processing based on the green-noise method can be suppressed. Also, generation of color heterogeneity in the error diffusion processing based on the green-noise method can be suppressed.

Further features of the present invention will become apparent from the following description of exemplary embodiments with reference to the attached drawings.

### BRIEF DESCRIPTION OF THE DRAWINGS

FIG. 1 is a view showing a state in which a feedback gain coefficient h of the green-noise method is changed upon applying error diffusion processing to tonal data (0 to 255).

FIGS. 2A to 2D are views showing the application results of error diffusion processing based on a green-noise method to cyan and magenta in a middle density range (a tonal value=120).

FIGS. 3A to 3C are views showing the application results of the error diffusion processing based on the green-noise method to cyan and magenta in a highlight region (a tonal value=192).

FIG. 4 is a view showing a color output obtained by independently processing three color components cyan, magenta, and yellow for a certain color, and compositing the processing results.

FIG. 5 is a block diagram showing the arrangement of an image processing apparatus according to an embodiment.

FIG. 6 is a block diagram showing the arrangement of a dot generator which generates a halftone screen.

FIG. 7 is a block diagram showing the arrangement of a binarizing processor which executes normal error diffusion processing.

FIG. 8 is a view showing the relationship between non-binarized pixels and distribution intensities.

FIG. 9 is a block diagram showing the arrangement of a binarizing unit which executes the error diffusion processing based on the green-noise method.

FIG. 10 is a view showing the relationship between reference pixels and reference intensities.

FIG. 11 is a view showing the binarization result by the green-noise method.

FIG. 12 is a view showing an output obtained by applying the error diffusion processing based on the green-noise method to an image having a uniform density (a tonal value=120).

FIG. 13 is a view showing the spatial frequency characteristic of the image shown in FIG. 12 by a two-dimensional FFT.

FIG. 14 is a graph showing the spectral intensities of a section taken along the ordinate of a spectrum pattern shown in FIG. 13.

FIG. 15 is view showing the error diffusion processing results of an image having a uniform density (a tonal value=120) using different parameters.

FIGS. 16A to 16C are views illustrating two-dimensional spectral distributions.

FIG. 17 is a view illustrating an output image in a middle density range of the error diffusion processing based on the green-noise method.

FIG. 18 is a view for explaining a beat of two wave vectors.

FIGS. 19A to 19C are views showing the results of the error diffusion processing based on the green-noise method of this embodiment, i.e., the processing results of an image having a middle density (a tonal value=120).

FIGS. 20A to 20C are views showing the results of the error diffusion processing based on the green-noise method without any frequency control, that is, the processing results of an image having a middle density (a tonal value=120) as in FIGS. 19A to 19C.

FIGS. 21A to 21C are views showing an application example of frequency control to a color image.

FIGS. 22A to 22F are views illustrating anisotropic spectral distributions of the spatial frequencies.

FIG. 23 is a view showing the error diffusion processing results of an image having a uniform density (a tonal value=120) by controlling anisotropy.

FIG. 24 is a view for explaining two-way scans.

FIG. 25 is a view showing the error diffusion processing results of an image having a uniform density (a tonal value=120) by controlling anisotropy.

FIG. 26 is a view for explaining forward scans and reverse scans.

FIGS. 27A to 27C are views showing processing result examples upon execution of anisotropy control in error diffusion processing.

FIG. 28 is a view for comparing two green-noise matrices and output patterns of binarization results.

FIG. 29 is a block diagram showing the arrangement of a binarizing processor which executes the error diffusion processing based on the green-noise method according to the third embodiment.

FIGS. 30A to 30C are views for explaining subband decompositions by Wavelet transformation.

FIG. 31 is a flowchart for explaining the processing of a selection unit.

FIG. 32 is a view showing reference pixel positions of the binarization result for the first color in the processing of the selection unit.

FIG. 33 is a block diagram showing the arrangement of a binarizing processor which executes the error diffusion processing based on the green-noise method according to the fourth embodiment.

FIG. 34 is a view showing the relationship between reference pixels and reference intensities for the first and second colors.

FIGS. 35A and 35B are views showing a composite example of the error diffusion processing results according to the fourth embodiment.

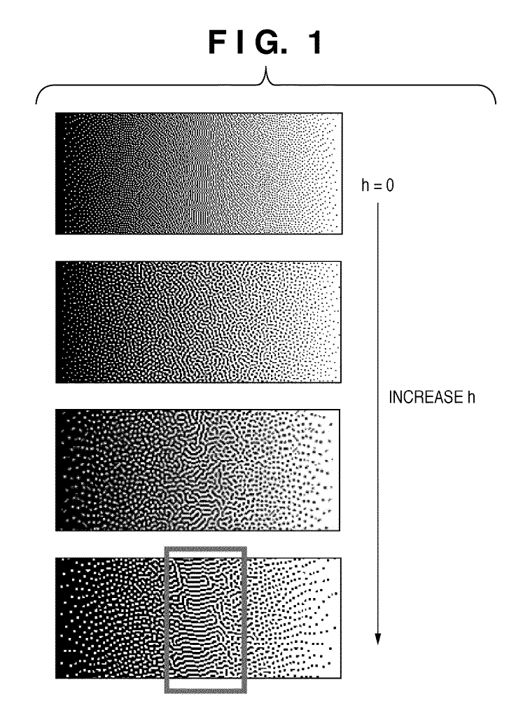

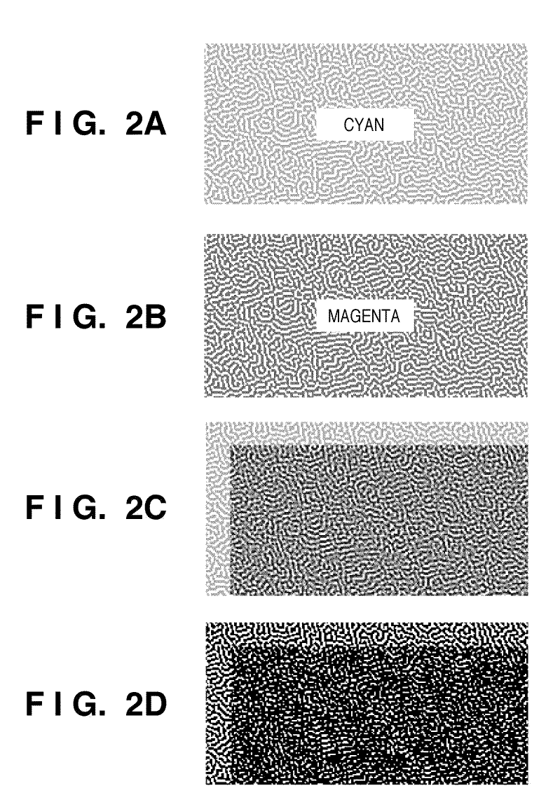

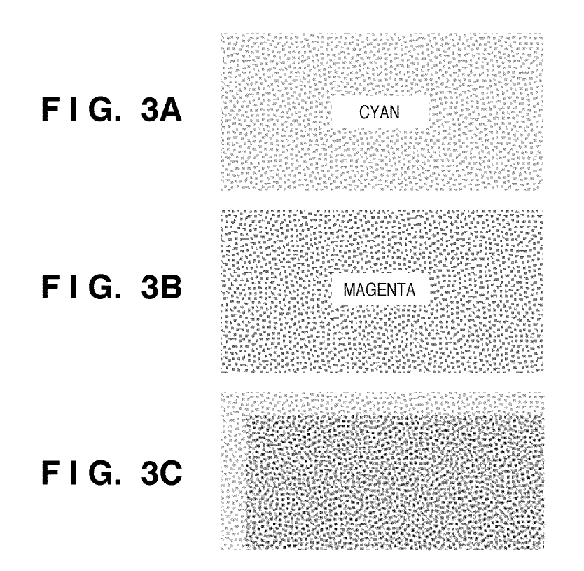

### DESCRIPTION OF THE EMBODIMENTS

Image processing according to embodiments of the present invention will be described in detail hereinafter with reference to the drawings.

### First Embodiment

### [Apparatus Arrangement]

FIG. 5 is a block diagram showing the arrangement of an image processing apparatus of this embodiment.

Functions of a multi-functional peripheral equipment (MFP) 10 having a scanner 11 and an electrophotographic printer 12 are controlled by its internal controller 13.

A microprocessor (CPU) 17 of the controller 13 executes an operating system (OS) and various programs stored in a read-only memory (ROM) 14 and hard disk drive (HDD) 16 using a random access memory (RAM) 15 as a work memory. The HDD 16 stores programs such as a control program and image processing program, and image data.

The CPU 17 displays a user interface on a display unit 18, and inputs user instructions from software keys on the display unit 18 and a keyboard of an operation panel 19. For example, when a user instruction indicates a copy instruction, the CPU 17 controls the printer 12 to print a document image scanned by the scanner 11 (copy function).

A communication unit 20 is a communication interface connected to a public line or network (although not shown). When a user instruction indicates a FAX transmission instruction, the CPU 17 controls the communication unit 20 to FAX-transmit a document image scanned by the scanner 11 to a destination designated by the user (FAX function). When a user instruction indicates a push scan instruction, the CPU 17 controls the communication unit 20 to transmit a document image scanned by the scanner 11 to a designated server apparatus (push scan function). When the communication unit 20 receives a FAX image, the CPU 17 controls the printer 12 to print the received image (FAX function). When the communication unit 20 receives a print job, the CPU 17 controls the printer 12 to print an image according to the print job (printer function). When the communication unit 20 receives a pull scan job, the CPU 17 controls the communication unit 20 to transmit a document image scanned by the scanner 11 to a designated server apparatus or client apparatus in accordance with the scan job (pull scan function).

### Dot Generator

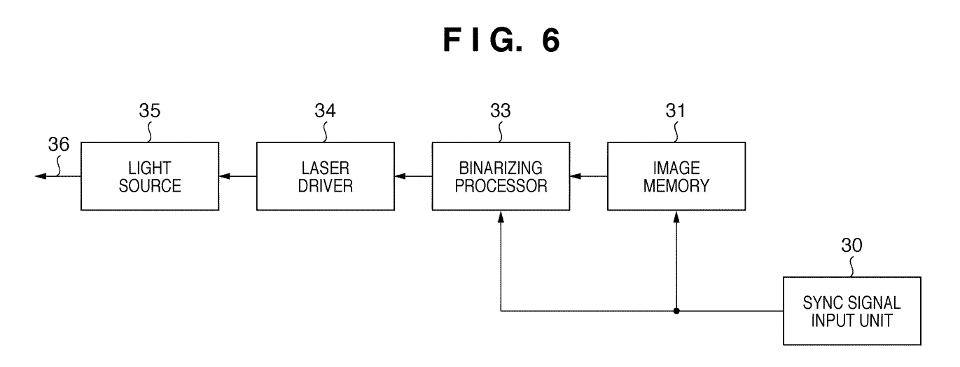

FIG. 6 is a block diagram showing the arrangement of a dot generator which generates a halftone screen. Note that the dot generator is configured as a part of the controller 13.

A sync signal input unit 30 inputs horizontal sync signals Hsync indicating the scan timings of one line, vertical sync signals Vsync indicating the scan timings of one page, and pixel clocks Vclock from the printer 12. These sync signals are sequentially input to an image memory 31 allocated on the RAM 15, and image data corresponding to a scan position of a photosensitive drum (not shown) is output.

The sync signals are sequentially input to a binarizing processor 33. The binarizing processor 33 binarizes image data input from the image memory 31.

A laser driver 34 drives a beam light source 35 according to a binary signal output from the binarizing processor 33 to control emission of the beam light source 35. For example, when a binary signal is ‘1’, the laser driver 34 controls the beam light source 35 to output a light beam 36 (laser ON). When a binary signal is ‘0’, the laser driver 34 controls the beam light source 35 not to output the light beam 36 (laser OFF).

A detailed description of an electrophotography process will not be given. A light beam scans the photosensitive drum of the printer 12 to form an electrostatic latent image on the photosensitive drum (light exposure). The electrostatic latent image is developed by toner, and is transferred onto a print sheet as a toner image. In order to form a color image, toner images of respective color components are multi-transferred onto a print sheet. After that, the print sheet is fed to a fixing device which fixes the toner image on the print sheet. The print sheet is then discharged outside the printer 12.

### [Binarizing Processor]

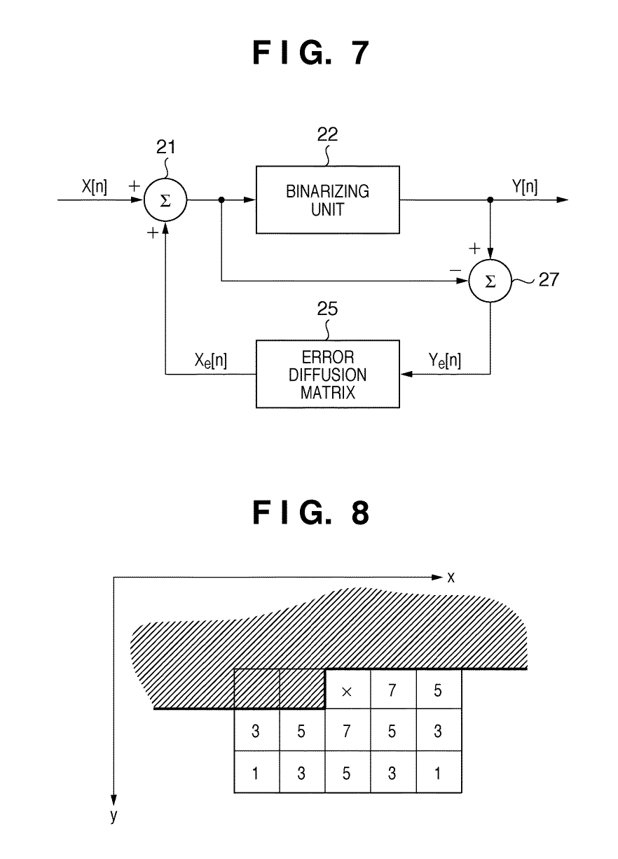

FIG. 7 is a block diagram showing the arrangement of the binarizing processor 33 which executes normal error diffusion processing.

A binarizing unit 22 binarizes N-th input pixel data X[n] and outputs output pixel data Y[n]. An error detector 27 outputs an error (difference) generated upon binarization of the input pixel data X[n] as error data Ye[n]. An error diffusion matrix 25 diffuses the error data Ye[n] to non-binarized pixels (pixels to be binarized). An adder 21 adds diffusion data Xe[n] output from the error diffusion matrix 25 to pixel data of non-binarized pixels to which an error is to be diffused.

FIG. 8 is a view showing the relationship between non-binarized pixels and diffusion intensities.

A pixel indicated by symbol X is a pixel of interest of binarization, x represents a main scan direction of recording, and y represents a sub-scan direction of recording. A hatched part above the pixel X of interest indicates binarized pixels (those after binarization), and pixels below the pixel X of interest are non-binarized pixels. Numerals given to the non-binarized pixels are diffusion ratios. For example, 7/48 of the error data Ye[n] are diffused to pixels which neighbor the pixel X of interest in the x and y directions, and 5/48 of the error data Ye[n] are diffused to obliquely lower right and lower left pixels of the pixel X of interest. That is, a diffusion value Xe of an error is added to input pixel data, as given by:

X=X+Xe (1)

The binarizing unit 22 executes binarization given by:
if (X≧Th)

Y=255;

else

Y=0; (2)

where Th is a threshold.

The spatial frequency characteristic of a recording pattern generated by an error diffusion method indicates a so-called blue-noise characteristic in which the spectral intensity of a low-frequency region is cut down. The blue-noise characteristic has an excellent resolution characteristic since the spatial frequency characteristic extends up to a high-frequency region, and exhibits satisfactory tone reproducibility since the densities of the image are locally preserved due to re-use of errors generated by binarization. Therefore, the error diffusion method is popularly used in ink-jet printers. However, the error diffusion method is not practically used in an electrophotographic printer since a stable output cannot be obtained.

An electrophotographic printer has an exposure process that scans a light beam to remove electric charges from a uniformly charged surface layer of a photosensitive drum of, for example, an organic photoconductor (OPC) or amorphous silicon. This exposure process has nonlinearity. Complexity of electrophotography processes including development, transfer, and fixing also causes nonlinearity. An interference occurs between print dots due to this nonlinear characteristic, thus considerably impairing tonality. For example, even when one independent dot is to be printed, it is difficult to record such dot, and dots are surely recorded in a cluster state of several dots. For this reason, the high-frequency characteristic is cut down, and tone reproducibility of a highlight region of an image deteriorates.

If a distance between dots is small, toner may move to connect dots. In the processes for recording dots by attaching ink drops onto a medium like in the ink-jet system, although a micro phenomenon between inks and a medium occurs, an interference between print dots hardly occurs, and dots can be surely recorded.

In other words, a recording pattern of a green-noise characteristic in which the spectral intensities are cut down not only in a low-frequency region but also in a high-frequency region is effective for an electrophotographic printer. Note that the arrangement and features of the green-noise method are described in detail in Daniel L. Lau & Gonzalo R. Arce, “Modern Digital Halftoning (Signal Processing and Communications)”, and U.S. Pat. No. 6,798,537.

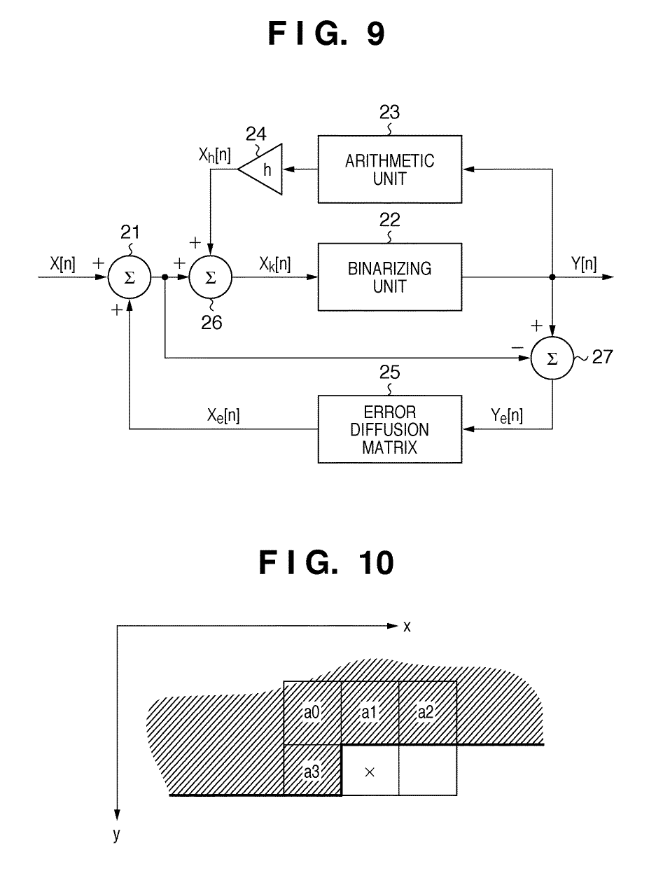

FIG. 9 is a block diagram showing the arrangement of the binarizing processor 33 which executes the error diffusion processing based on the green-noise method.

A binarizing unit 22 binarizes N-th input pixel data X[n] and outputs output pixel data Y[n]. An error detector 27 outputs an error (difference) generated upon binarization of the input pixel data X[n] as error data Ye[n] . An error diffusion matrix 25 diffuses the error data Ye[n] to non-binarized pixels. An adder 21 adds diffusion data Xe[n] output from the error diffusion matrix 25 to pixel data of non-binarized pixels to which an error is to be diffused. The processing described so far is the same as that of the error diffusion processing shown in FIG. 7.

An arithmetic unit 23 acquires values of a plurality of binarized pixels (to be referred to as reference pixels hereinafter) using a reference pixel matrix to be described later, and applies a predetermined arithmetic operation. A gain adjustor 24 calculates data Xh[n] by multiplying data output from the arithmetic unit 23 by a predetermined gain h. An adder 26 adds the data Xh[n] to pixel data output from the adder 21. The binarizing unit 22 inputs pixel data Xk[n] to which the error and data Xh[n] are added.

That is, Xh is a feedback amount (green-noise data).

Xk=X+Xe+Xh (3)

Also, the binarizing unit 22 executes binarization given by:
if (Xk≧Th)

Y=255;

else

Y=0; (4)

where Th is a threshold.

FIG. 10 is a view showing the relationship between reference pixels and reference intensities.

As in FIG. 8, a pixel indicated by symbol X is a pixel of interest of binarization, x represents a main scan direction of recording, and y represents a sub-scan direction of recording. A hatched part above the pixel X of interest indicates binarized pixels. Binarized pixels indicated by a0, a1, a2, and a3 are reference pixels, and values a0, a1, a2, and a3 are weighting coefficients (reference intensities). Note that the reference pixels are binarized pixel in the vicinity of the pixel X of interest, and image quality largely changes depending on selection of the reference pixels. A weighting coefficient ai=0 represents that data of the corresponding binarized pixel is not referred to, and the weighting coefficients ai are normalized to have Σai=1. The output from the gain adjustor 24 is given by:

Xh[n]=h×Σᵢ(ai×Yi) (5)

where h is a gain coefficient, and

Yi is a value (0 or 255) of the i-th reference pixel.

### Binarization Result by Green-noise Method

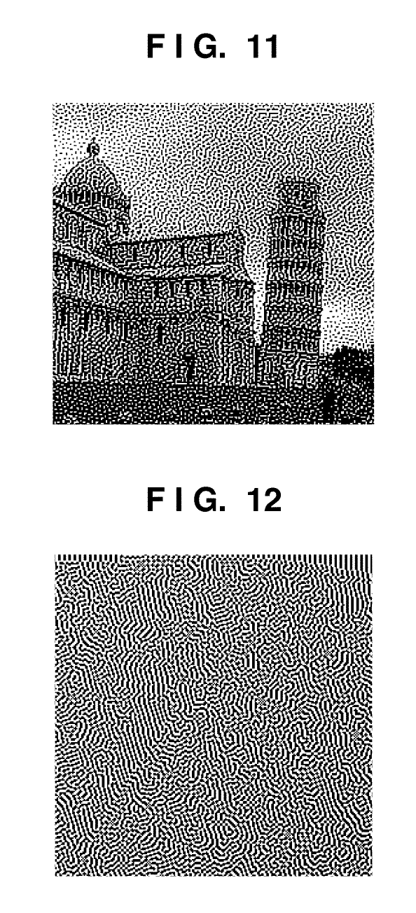

FIG. 11 is a view showing the binarization result by the green-noise method. An error diffusion matrix E1 used in this error diffusion processing is called a Jarvis Matrix, and is described by:

$$E 1 = \frac{1}{48} \times [ \begin{matrix}\cdot & \cdot & X & 7 & 5 \\ 3 & 5 & 7 & 5 & 3 \\ 1 & 3 & 5 & 3 & 1\end{matrix} ] \qquad ( 6 )$$

where X is the position of the pixel of interest.

A reference pixel matrix C2 is given by:

$$C 2 = \frac{1}{2} \times [ \begin{matrix}0 & 1 \\ 1 & X\end{matrix} ] \qquad ( 7 )$$

where X is the position of the pixel of interest.

In the following description, the reference pixel matrix may also be called a “green-noise matrix”.

The gain coefficient h is 0.2. The output of the error diffusion processing based on the green-noise method exhibits a dot pattern which is shifted to a low-frequency region compared to the output of the normal error diffusion processing. This results from a clustering effect that rises the probability of following the characteristics of reference pixels (to set “0” if a reference pixel is “0”; “255” if a reference pixel is “255”) since binarized pixel data are fetched. This clustering effect becomes stronger with increasing gain coefficient h. When the gain coefficient h is increased, clustered dots have anisotropic textured structures, and an unnecessarily large value of the gain coefficient h cannot be used.

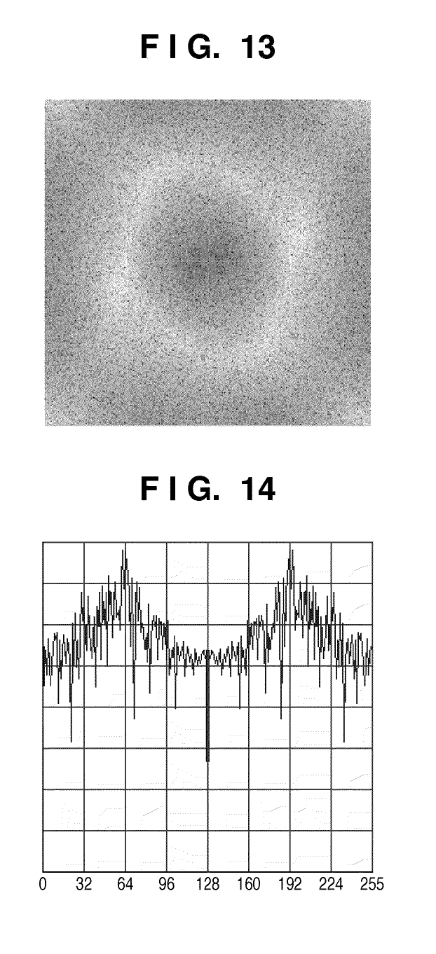

FIG. 12 is a view showing the output as a result of the error diffusion processing of an image having a uniform density (a tonal value=120) based on the green-noise method. FIG. 13 is a view showing the spatial frequency characteristic of the image shown in FIG. 12 by two-dimensional Fourier transformation (FFT). White regions are those having large spectral intensities. FIG. 14 is a view showing the spectral intensities of a section taken along the ordinate of a spectrum pattern shown in FIG. 13. As can be seen from FIGS. 13 and 14, the frequency spectrum exhibits a doughnut-shaped intensity distribution, that is, a green-noise characteristic having cut-down low- and high-frequency regions.

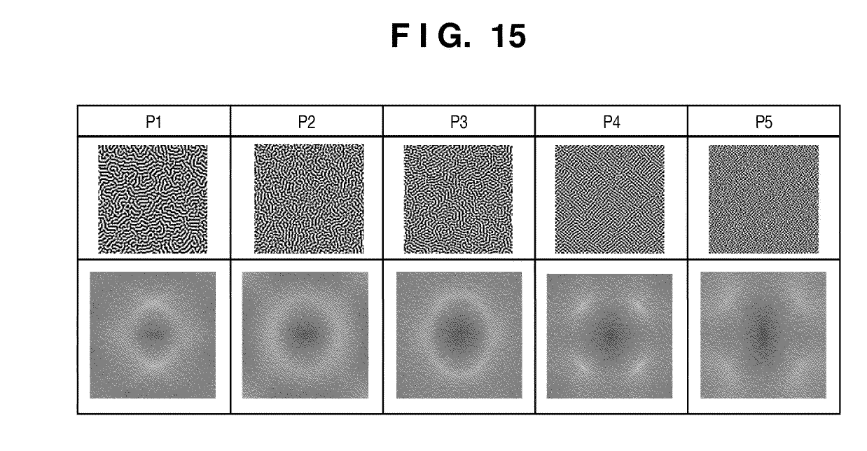

FIG. 15 is a view showing the error diffusion processing results of an image having a uniform density (a tonal value=120) using different parameters. The table below shows the relationship between the processing results and parameters.

TABLE 1

| | Error | | | | |
|---|---|---|---|---|---|
| | diffusion | Green-noise | Scan | Gain | Random |
| | matrix | matrix | direction | coefficient h | value |
| P1 | Ring | C3 | Two ways | 0.2 | ±10 |
| P2 | Ring | — | Forward | 0.0 | ±20 |
| P3 | Jarvis (E1) | C2 | Two ways | 0.3 | ±10 |
| P4 | Floyd | C2 | Two ways | 1.0 | ±10 |
| P5 | E2 | C2 | Two ways | 0.5 | ±10 |

“Scan direction” in Table 1 will be described later. The parameter P2 has a gain coefficient h=0, and does not use the green-noise method. A random value is added to a binarization threshold upon applying error diffusion to a flat tonal image on a trial basis. Error diffusion matrices “Ring”, “Floyd”, and “E2”, and a green-noise matrix “C3” are respectively given by:

$$\begin{matrix}Ring = \frac{1}{6} \times [ \begin{matrix}\cdot & \cdot & X & 0 & 1 \\ 1 & 0 & 0 & 0 & 1 \\ 0 & 1 & 1 & 1 & 0\end{matrix} ] & ( 8 ) \\ Floyd = \frac{1}{16} \times [ \begin{matrix}\cdot & X & 7 \\ 3 & 5 & 1\end{matrix} ] & ( 9 ) \\ E 2 = \frac{1}{2} \times [ \begin{matrix}X & 1 \\ 1 & 0\end{matrix} ] & ( 10 ) \\ C 3 = \frac{1}{3} \times [ \begin{matrix}1 & 1 \\ 1 & X\end{matrix} ] & ( 11 )\end{matrix}$$

As described above, a density range having a tonal value=120 is that in which dot connections begin, and periodic patterns are generated. In FIG. 15, produces a coarsest pattern (a spectrum having the spatial frequency falling within a low-frequency range), and P5 produces a finest pattern (a spectrum having the spatial frequency falling within a high-frequency range). That is, finer patterns are formed from P1 to P5, and the peak of the spectrum shifts to a high-frequency region of the spatial frequency. A method of forming a color image free from color moiré and color heterogeneity by combining these patterns will be described below.

[Generation Principle of Color Moiré]

In order to prevent color moiré from being generated between different colors, the spatial frequency spectra of respective colors are required to be prevented from any superimposition.

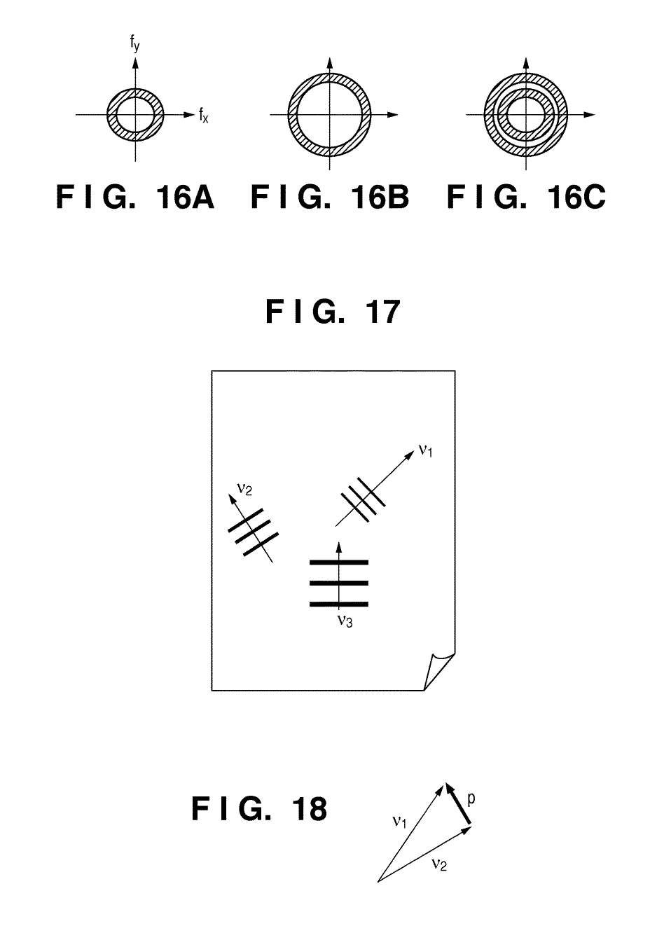

FIGS. 16A to 16C are views illustrating two-dimensional spectral distributions, the abscissa plots frequencies fx in the x direction, and the ordinate plots frequencies fy in the y direction. FIG. 16A shows an example in which the spectral distribution is located in a low-frequency region, and FIG. 16B shows an example in which the spectral distribution is located in a high-frequency region. FIG. 16C shows an example in which the spectral distributions in FIGS. 16A and 16B are superimposed. As shown in FIG. 16C, when the spectral distributions are free from any superimposition, color moiré is hardly generated.

A moiré phenomenon is explained as a mutual interference phenomenon between wave vectors based on the periodic structures of connected dots. Assume that a micro part of a dot pattern of an image is formed by dots connected in a pattern of several parallel lines, and the interval between lines is λ. A wave vector \vec{v} based on this micro structure is expressed by:

$$\vec{v} = \frac{2 π}{λ} \cdot ( \frac{\vec{i}}{i} ) \qquad ( 12 )$$

where \vec{i} is a direction vector perpendicular to periodic lines.

FIG. 17 is a view illustrating an output image of a middle density range of the error diffusion processing based on the green-noise method. In the middle density range of the output image, micro periodic structures are locally distributed in countless numbers, as shown in FIG. 17.

The moiré phenomenon is described as a beat of superimposed wave vectors. FIG. 18 is a view for explaining a beat of two wave vectors. That is, as shown in FIG. 18, letting \vec{v1} be a wave vector of the first color at an arbitrary point, and \vec{v2} be a wave vector of the second color, a wave vector \vec{p} of a beat to be generated is expressed by:

\vec{p}=\vec{v1}−\vec{v2} (13)

That is, when the wave vector \vec{p} is small, a beat of a long wavelength, that is, color moiré is generated.

### [Frequency Control]

This embodiment applies, for example, one of the parameters P1 to P5 shown in FIG. 15 to binarization of respective color components, thereby removing or eliminating any color moiré by avoiding superimposition of the spectral distributions of the spatial frequencies of the binarization results.

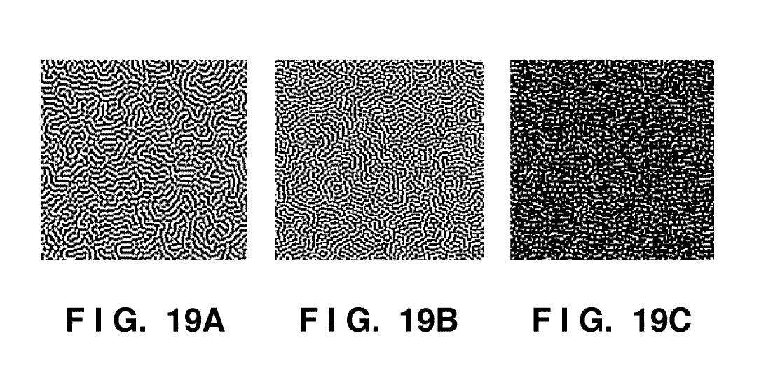

FIGS. 19A to 19C show the results of the error diffusion processing based on the green-noise method according to this embodiment, and show the processing results of an image having a middle density (a tonal value=120). FIG. 19A shows the processing result using the parameter P1. A ring-shaped matrix (a ring matrix; the error diffusion matrix given by equation (8)) of the parameter P1 has a characteristic of diffusing an error to non-binarized pixels which are separated by a predetermined distance from a pixel of interest, and are located to form a ring pattern, and exhibits a large low-pass filter characteristic by a small matrix size. As a result, a coarse dot pattern is generated. FIG. 19B shows the processing result using the parameter P3. FIG. 19C shows an image obtained by superimposing the processing results shown in FIGS. 19A and 19B.

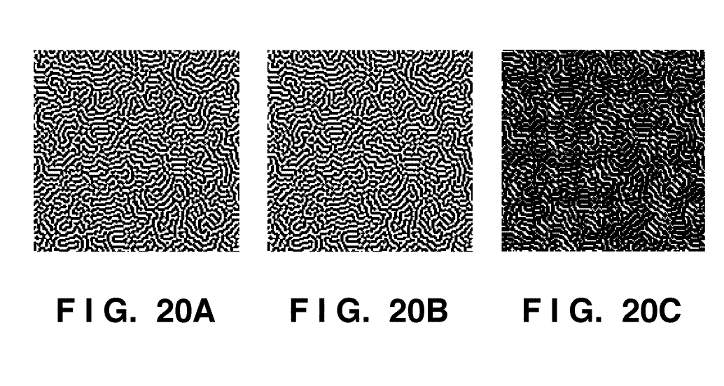

FIGS. 20A to 20C show the results of the error diffusion processing based on the green-noise method without any frequency control, and show the processing results of an image having a middle density (a tonal value=120) as in FIGS. 19A to 19C. Both FIGS. 20A and 20B show the processing results using the parameter P1. When these results are superimposed (FIG. 20C), wave vectors are superimposed, and a larger low-frequency beat (moiré ) than FIG. 19C is generated of course, as can be seen from FIG. 20C, strong moiré is generated, and this method is sensitive to registration variations and has poor stability.

In other words, when different parameters are used depending on color components like a combination of the parameters P1 and P3 in FIG. 19C, generation of color moiré can be suppressed in a pattern obtained by compositing the error diffusion processing results.

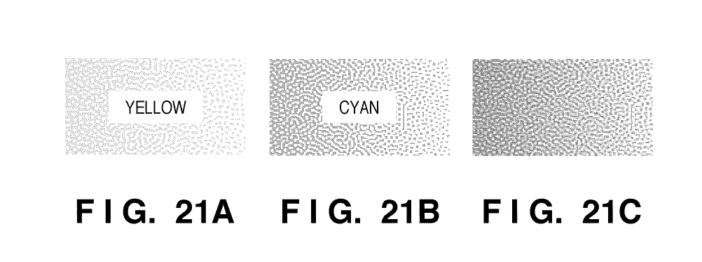

FIGS. 21A to 21C are views showing an example in which frequency control is applied to a color image. FIG. 21A shows the processing result obtained when the parameter P1 is used for a yellow component. FIG. 21B shows the processing result obtained when the parameter P3 is used for a cyan component. FIG. 21C shows an image obtained by superimposing the processing results of FIGS. 21A and 21B. Note that the yellow component is hard to be visually perceived. Therefore, application of the parameter used to generate a coarsest dot pattern (P1 in the example of FIG. 15) to the yellow component is effective to suppress a practical resolution drop of a color image and to hold color stability and homogeneity.

### Second Embodiment

Image processing according to the second embodiment of the present invention will be described hereinafter. Note that the same reference numerals in the second embodiment denote the same components as in the first embodiment, and a detailed description thereof will not be given.

The first embodiment has explained the method of preventing color moiré generated upon superimposing two color component images by the frequency control. However, it is difficult only for the frequency control to avoid color moiré generated when four color component images of yellow, magenta, cyan, and black are superimposed. Hence, the second embodiment will explain a method of avoiding color moiré generated upon superimposing four color component images by introducing anisotropy control of frequencies.

### [Anisotropy Control]

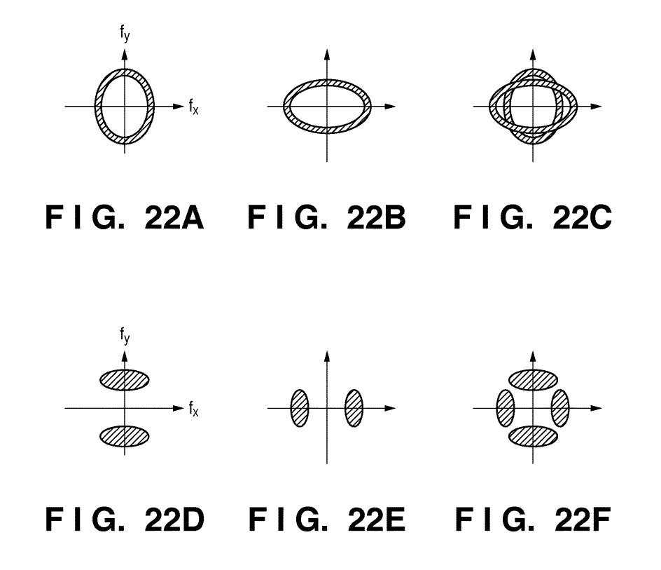

FIGS. 22A to 22F are views illustrating the anisotropic spectral distributions of the spatial frequencies. FIG. 22A shows the spectral distribution extended in the y direction, FIG. 22B shows the spectral distribution extended in the x direction, FIG. 22C shows a composite state of the spectral distributions shown in FIGS. 22A and 22B. FIG. 22D shows the spectral distributions distributed on the y-axis, FIG. 22E shows the spectral distributions distributed on the x-axis, and FIG. 22F shows a composite state of the spectral distributions shown in FIGS. 22D and 22E. As shown in FIGS. 22A to 22F, superimposition of the spectral distributions is reduced by controlling anisotropy of the spectral distributions, thereby eliminating generation of moiré.

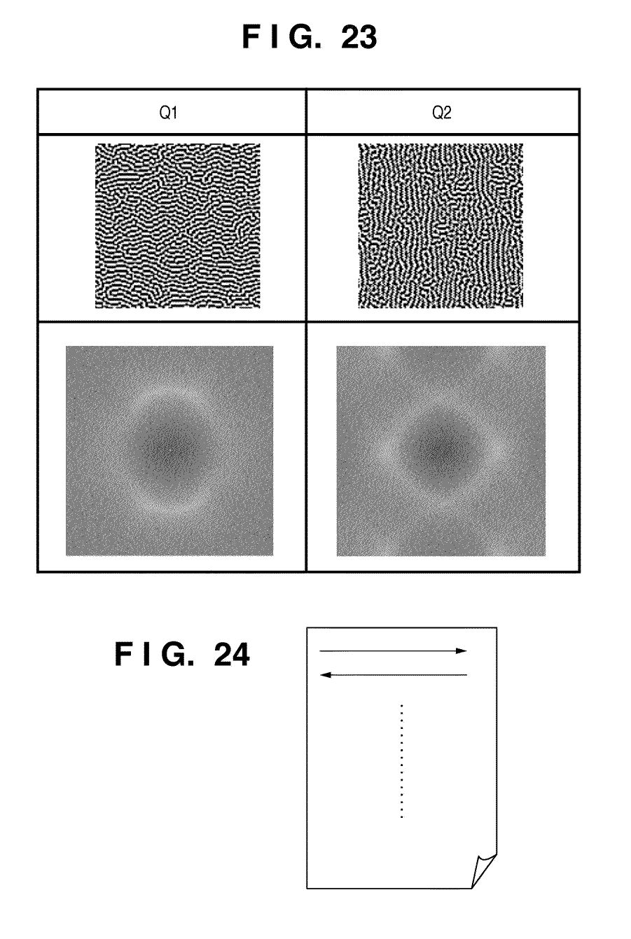

FIG. 23 is a view showing the results of the error diffusion processing of an image having a uniform density (a tonal value=120) by controlling its anisotropy. The table below shows the relationship between the processing results and parameters.

TABLE 2

| | Error | | | | |
|---|---|---|---|---|---|
| | diffusion | Green-noise | Scan | Gain | Random |
| | matrix | matrix | direction | coefficient h | value |
| Q1 | Jarvis (E1) | C2 | Two ways | 0.4 | ±10 |
| Q2 | Jarvis (E1) | C4 | Two ways | 0.4 | ±10 |

A green-noise matrix C4 in Table 2 is given by:

$$C 4 = \frac{1}{4} \times [ \begin{matrix}2 & 1 \\ 1 & X\end{matrix} ] \qquad ( 14 )$$

FIG. 24 is a view for explaining two-way scans, and scans, the direction of which is reversed every scan, are made for a raster image. In this case, the directions of the error diffusion matrix and green-noise matrix are set to fit the scan directions. In other words, in case of a scan from the right to the left, the configurations of the error diffusion matrix and green-noise matrix are horizontally inverted. Therefore, a pattern symmetric to the y-axis is generated in the main scan direction.

The parameter Q1 is characterized in that dots are connected to form patterns directed in the vertical direction (corresponding to the spectral distribution of FIG. 22A) by making two-way scans using the green-noise matrix C2 given by equation (7). Also, the parameter Q2 is characterized in that dots are connected to form patterns directed in the horizontal direction (corresponding to the spectral distribution of FIG. 22B) by making two-way scans using the green-noise matrix C4 given by equation (14).

By forming these patterns, the wave vectors of their wave vectors are orthogonal to each other, the beat \vec{p} given by equation (13) has a high frequency, and color moiré is hardly perceived by a human visual characteristic.

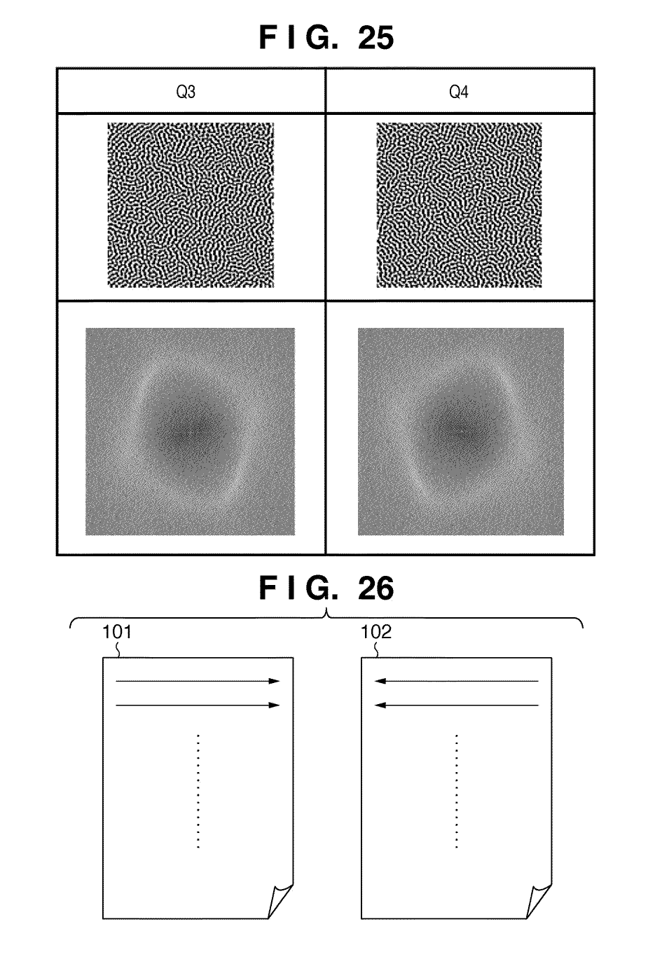

FIG. 25 is a view showing the error diffusion processing results of an image having a uniform density (a tonal value=120) by controlling its anisotropy. The table below shows the relationship between the processing results and parameters.

TABLE 3

| | Error | | | | |
|---|---|---|---|---|---|
| | diffusion | Green-noise | Scan | Gain | Random |
| | matrix | matrix | direction | coefficient h | value |
| Q3 | Jarvis (E1) | C2 | Forward | 0.2 | ±10 |
| Q4 | Jarvis (E1) | C2 | Reverse | 0.2 | ±10 |

FIG. 26 is a view for explaining forward and reverse scans, and shows that forward scans are made for a certain color component image 101, and reverse scans are made for another color component image 102 of course, in case of reverse scans, the directions of the error diffusion matrix and green-noise matrix are set to fit the scan direction. In other words, in case of reverse scans from the right to the left, the configurations of the error diffusion matrix and green-noise matrix are horizontally inverted.

Note that reverse scans may be made by horizontally inverting image data. In this case, the need for inverting the matrices can be obviated, but image data as the error diffusion processing result has to be horizontally inverted.

Both the parameters Q3 and Q4 are characterized in that dots are connected to form patterns directed in symmetrically oblique directions since they have different scan directions although they use the green-noise matrix C2 given by equation (7).

By forming these patterns, the wave vectors of these patterns are orthogonal to each other, the beat \vec{p} given by equation (13) has a high frequency, and color moiré is hardly perceived by a human visual characteristic.

Note that the parameter Q3 uses the green-noise matrix C2 given by equation (7). As described above, the green-noise method is characterized by forming dot patterns in which dots are connected in a lower left to upper right (right oblique) direction, since it has a high probability of following the characteristics of reference pixels (to set “0” if a reference pixel is “0”; “255” if a reference pixel is “255”). Likewise, the parameter Q4 is characterized by forming dot patterns in which dots are connected in an upper left to lower right (left oblique) direction.

As described above, by appropriately setting the parameters of the error diffusion processing, the anisotropy of dot patterns to be formed can be controlled.

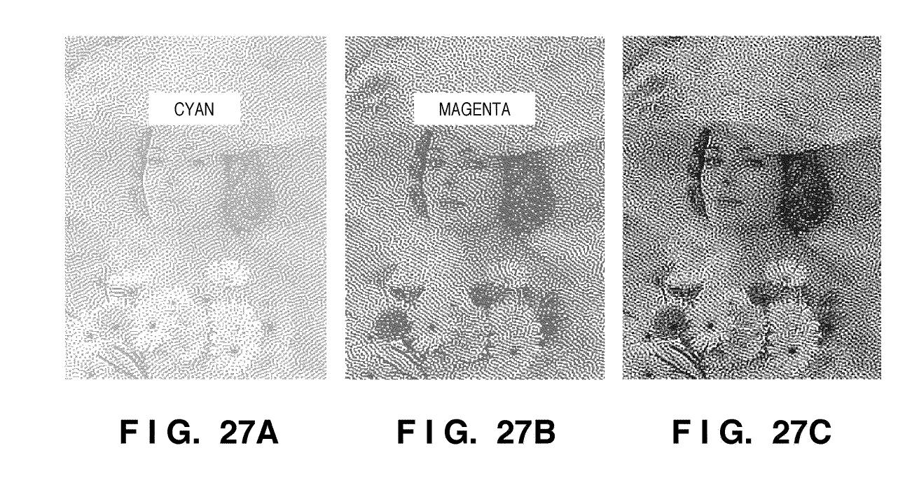

FIGS. 27A to 27C are views showing processing result examples obtained by executing the anisotropy control in the error diffusion processing. FIG. 27A shows the result of the error diffusion processing of a cyan component image using the parameter Q3, and FIG. 27B shows the result of the error diffusion processing of a magenta component image using the parameter Q4. FIG. 27C shows a two-color composite image formed by superimposing the results shown in FIGS. 27A and 27B. Since cyan and magenta dot patterns are intersect to make nearly right angles (nearly orthogonal to each other), generation of color moiré of an image formed by superimposing these patterns can be suppressed.

### Third Embodiment

Image processing according to the third embodiment of the present invention will be described hereinafter. Note that the same reference numerals in the third embodiment denote the same components as in the first and second embodiments, and a detailed description thereof will not be given.

The third embodiment will explain a method of adaptively executing binarization of the second color in accordance with a pattern of the binarization result of the first color.

An image which has undergone the error diffusion processing based on the green-noise method depends on the shape (coefficients) of the green-noise matrix.

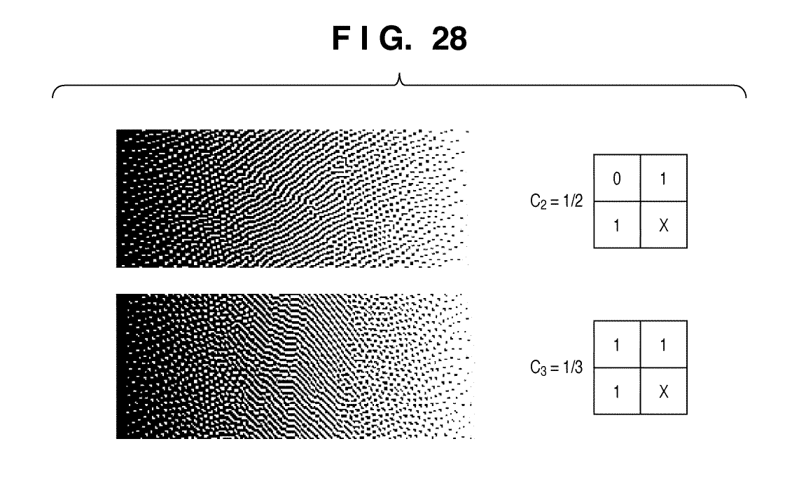

FIG. 28 is a view for comparing two green-noise matrices and output patterns of the binarization results. When the green-noise matrix C2 is used, an output pattern in which dots are connected in a lower left to upper right (right oblique) direction tends to be formed. On the other hand, when the green-noise matrix C3 is used, an output pattern in which dots are connected in an upper left to lower right (left oblique) direction tends to be formed. This is because the green-noise method forms dot arrays that follow a reference pattern (that of the green-noise matrix) since it has a high probability of following the characteristics of reference pixels (to set “0” if a reference pixel is “0”; “255” if a reference pixel is “255”), as described above.

By using the aforementioned characteristic features, when a pattern near the pixel of interest of a color component image of the first color exhibits a right oblique pattern, the green-noise matrix C3 is selected in binarization of a color component image of the second color. On the other hand, when the pattern exhibits a left oblique pattern, the green-noise matrix C2 is selected. Then, by superimposing the two binarization results, nearly orthogonal patterns are superimposed, thus eliminating generation of color moiré.

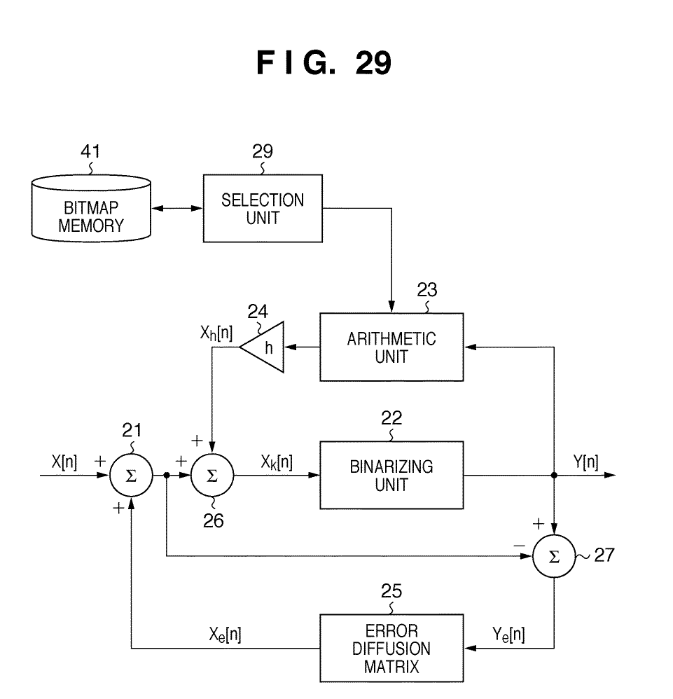

FIG. 29 is a block diagram showing the arrangement of the binarizing processor 33 which executes the error diffusion processing based on the green-noise method according to the third embodiment.

A selection unit 29 outputs a selection signal of the green-noise matrix with reference to the binarization result of a color component image of the first color, which is stored in a bitmap memory 41 allocated on a RAM 15 or HDD 16. An arithmetic unit 23 performs a predetermined arithmetic operation by acquiring the values of reference pixels indicated by the green-noise matrix according to the selection signal.

In order to calculate a selection signal, the selection unit 29 has to calculate a feature amount from the binarization result of a color component image of the first color near the pixel of interest. A method most effective for this feature amount arithmetic operation is to execute local spatial frequency spectrum analysis.

As the local spatial frequency spectrum analysis, subband decompositions based on Wavelet transformation are effective. Note that Fourier transformation can obtain the spectral distribution of an entire image, but it cannot obtain a local spectral distribution.

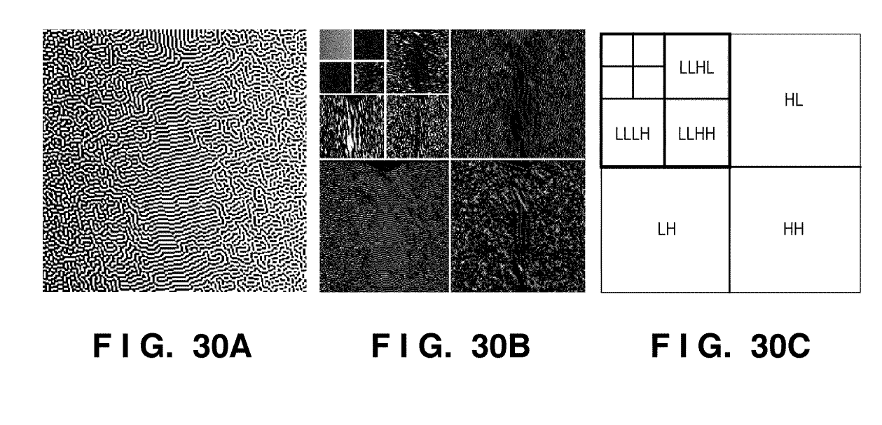

FIGS. 30A to 30C are views for explaining subband decompositions based on Wavelet transformation. FIG. 30A shows the application result of the error diffusion processing based on the green-noise method to a grayscale image in which a tonal value changes within a range from 96 to 160 in the horizontal direction. A parameter in this case includes the error diffusion matrix given by equation (8) (Ring), the green-noise matrix C2 given by equation (7), and the gain coefficient h=0.2.

As shown in FIG. 30A, periodic structures appear near the center (a tonal value=128) of the image. FIG. 30B shows the result of rank 3 Wavelet transformation of the image shown in FIG. 30A in three layers, and white regions are those with strong spectral intensities. FIG. 30C shows indices of respective Wavelet subbands. A strong spectral intensity part appears at the center of an LLLH region of a second subband bounded by the bold line in FIG. 30B, and the spectral intensity of a corresponding LLHL region is weak. The second subband is a region subband-decomposed to a ½ frequency. Therefore, the LLLH region represents the spectral intensity in the y direction (vertical direction) of the ½ frequency, and the stronger spectrum of the LLLH region than other bands means that clustering in two-pixel units is made in the horizontal direction. That is, when a weak spectral intensity part of the second image is superimposed on the strong spectral intensity part of the LLLH region, it is expected to hardly cause an interference. That is, a micro incoherent pattern can be adaptively formed based on the local analysis result of the Wavelet transformation.

However, the Wavelet transformation requires a long processing time. Hence, in the third embodiment, the local spatial frequency spectrum analysis is executed by a simple method on a real space.

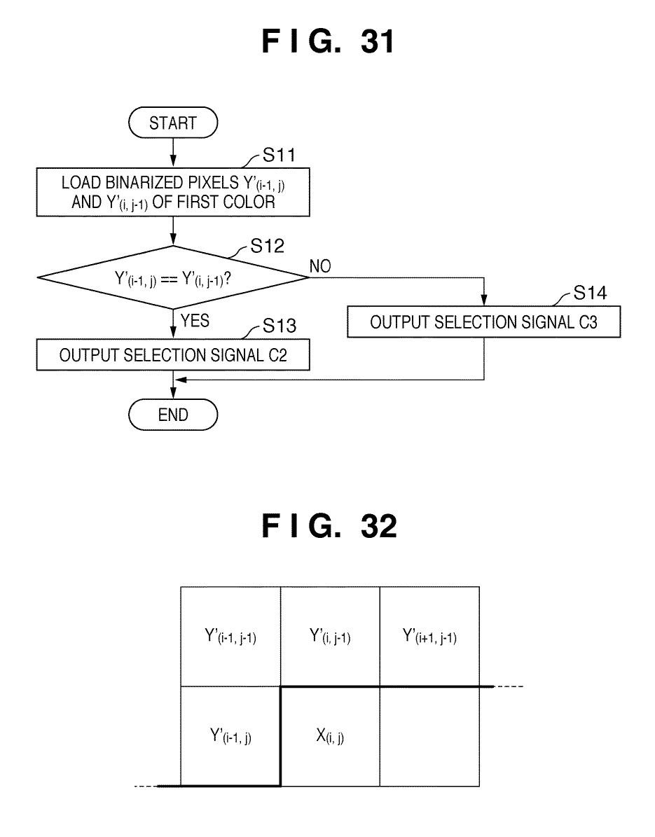

FIG. 31 is a flowchart for explaining the processing of the selection unit 29. FIG. 32 is a view showing the reference pixel positions of the binarization result of the first color in the processing of the selection unit 29.

Upon binarizing a color component image of the second color, the selection unit 29 loads binarized pixels Y′(i−1, j) and Y′(i, j−1) of the first color, which are stored in the bitmap memory 41, in correspondence with a pixel X(i,j) of interest (S11). The selection unit 29 compares the values of the two binarized pixels (S12), and if Y′(i−1, j)=Y′(i, j−1), the selection unit 29 outputs a selection signal C2 indicating selection of the green-noise matrix C2 (S13). If Y′(i−1,j)≠Y′(i, j−1), the selection unit 29 outputs a selection signal C3 indicating selection of the green-noise matrix C3 (S14).

That is, the selection of the green-noise matrices C2 and C3 is described by:

if (Y′(i−1, j)==Y′(i, j−1)) C2;

else

C3; (15)

The selection of the green-noise matrices C2 and C3 is made for each pixel, and the color component image of the second color adaptively undergoes error diffusion processing by the selected green-noise matrix.

The selection unit 29 refers to binarized pixels in the same line as the pixel of interest and the previous line. Upon frame-sequentially processing a color component image, since the bitmap memory 41 stores the binarization result of the first color, there is no limitation on selection of reference pixels (in other words, the binarization results of lines after the line of the pixel of interest can also be referred to). However, when no buffer memory for reference pixels is arranged, reference pixels are limited to pixels on the same line as the pixel of interest in case of line-sequential processing, or a reference pixel is limited to a pixel at the same position as the pixel of interest in case of dot-sequential processing. In order to simplify processing, pixels which neighbor the pixel of interest are preferably used as reference pixels. However, when clustered dots become large, it is desired to refer to pixels located at positions separate away from the pixel of interest by adding a buffer memory.

### Fourth Embodiment

Image processing according to the fourth embodiment of the present invention will be described hereinafter. Note that the same reference numerals in the fourth embodiment denote the same components as in the first to third embodiments, and a detailed description thereof will not be given.

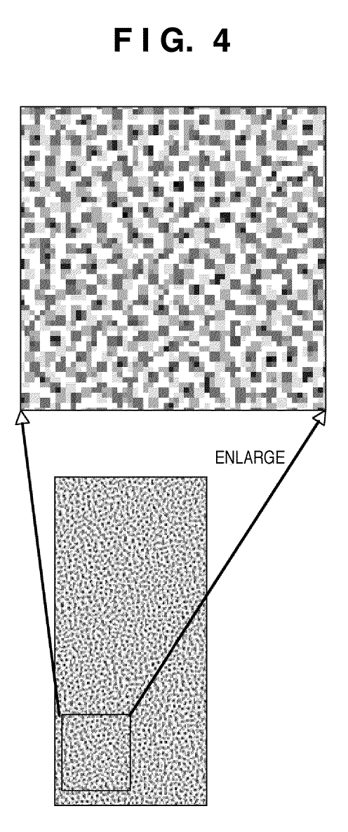

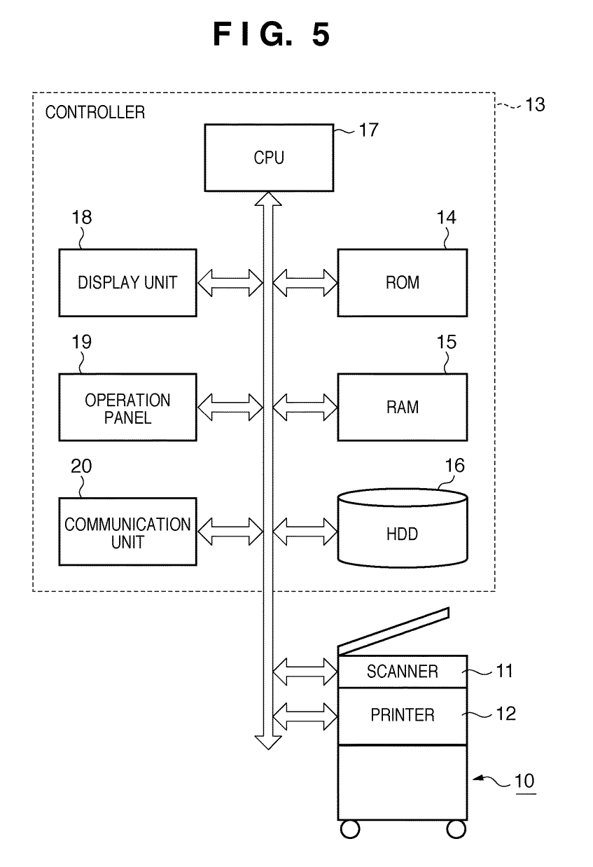

As shown in FIG. 4, when respective color component images are independently processed and are then composited, dot positions of respective colors are randomly allocated, and a part where color dots are superimposed (subtractive mixture) and a part where color dots are adjacently arranged (additive mixture) are generated, thus causing color heterogeneity.

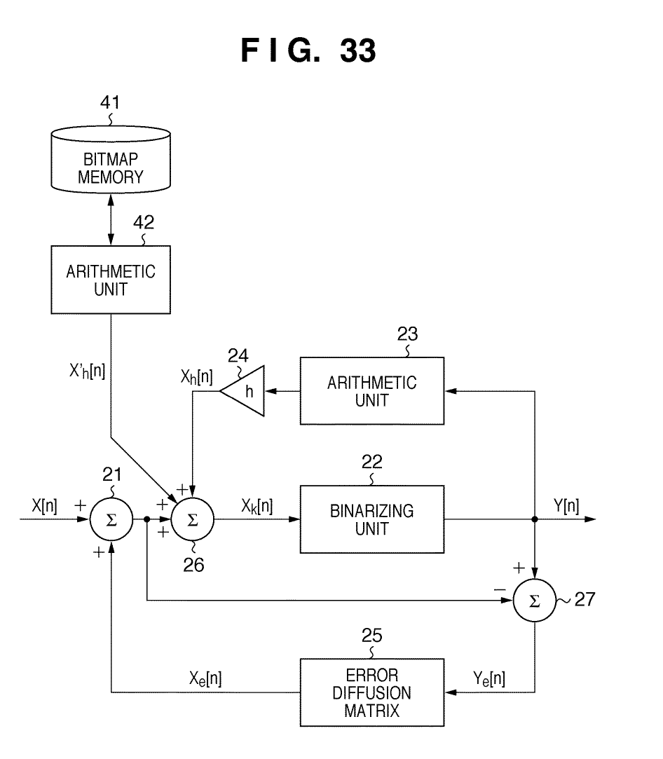

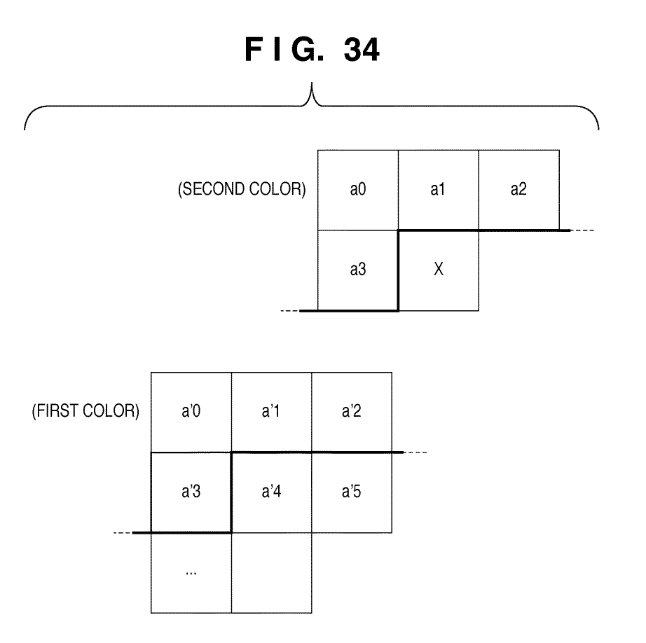

FIG. 33 is a block diagram showing the arrangement of a binarizing processor 33 which executes the error diffusion processing based on the green-noise method according to the fourth embodiment. FIG. 34 is a view showing the relationships between reference pixels and reference intensities of the first and second colors.

An arithmetic unit 42 outputs a feedback amount Xh′ with reference to the binarization result of a color component image of the first color, which is stored in a bitmap memory 41. An adder 26 calculates data Xk to be input to a binarizing unit 22 with respect to a pixel X of interest of a color component image of the second color by:

Xk=X+Xe+Xh+Xh′ (16)

where Xh=hΣᵢaiYi, and

Xh′=h′Σᵢa′iY′i.

In equation (16), Xh is the feedback amount (green-noise data) of the second color, and Xh′ is the feedback amount of the first color (binarized color component image). That is, to the data Xk input to the binarizing unit 22 with respect to the pixel X of interest of the second color, the feedback amount Xh′ of the first color is added in addition to the feedback amount Xh of the second color. The feedback amount Xh′ of the first color is a product-sum operation result of binarized pixel values Y′0, Y′1, Y′2, . . . , of the first color near the pixel of interest, and weighting coefficients a′0, a′1, a′2, . . . .

Note that the aforementioned processing is applicable to frame-sequential, line-sequential, or dot-sequential processing of raster data of each color component image. However, upon frame-sequentially processing a color component image, since the bitmap memory 41 stores the binarization result of the first color, there is no limitation on selection of reference pixels (in other words, the binarization results of lines after the line of the pixel of interest can also be referred to). However, when no buffer memory for reference pixels is arranged, reference pixels are limited to pixels on the same line as the pixel of interest in case of line-sequential processing, or a reference pixel is limited to a pixel at the same position as the pixel of interest in case of dot-sequential processing. In order to simplify processing, pixels which neighbor the pixel of interest are preferably used as reference pixels. However, when clustered dots become large, it is desired to refer to pixels located at positions separate away from the pixel of interest by adding a buffer memory.

[Processing from Third Color]

The error diffusion processing based on the green-noise method for channel n to have the first color as channel 1, the second color as channel 2, . . . will be described below.

Input data Xk⁽ⁿ⁾ of the binarizing unit 22 with respect to a pixel x⁽ⁿ⁾ of interest of channel n is expressed by:

Xk⁽ⁿ⁾=X⁽ⁿ⁾+Xe⁽ⁿ⁾+Xh⁽ⁿ⁾−Σₘ₋₁ⁿ⁻¹Xh^{(m)} (17)

where Xh⁽ⁿ⁾ is the feedback amount of channel n, i.e., Xh⁽ⁿ⁾=hΣᵢaiYi, and

ΣXh^{(m)} is the feedback amount of channels 1 to n−1 that have been binarized, i.e., Xh^{(m)}=h^{(m)}Σᵢa′iY′i.

In equation (17), Xh⁽ⁿ⁾ is the feedback amount of channel n, and Xh^{(m)} is the feedback amount of channels 1 to n−1 (binarized color component images). That is, to the data Xk input to the binarizing unit 22 with respect to the pixel X of interest of channel n, the feedback amount ΣXh^{(m)} of channels 1 to n-1 is added in addition to the feedback amount Xh⁽ⁿ⁾ of channel n. A feedback amount Xh^{(m)} of channel m is a product-sum operation result of binarized pixel values Y′0, Y′1, Y′2, . . . , of channel m near the pixel of interest, and weighting coefficients a′0, a′1, a′2, . . . .

The simplest method is a method which uses only the binarized pixel values corresponding to the pixel of interest in calculation of the feedback amount Xh^{(m)} of channels 1 to n−1, and is given by:

Xh^{(m)}=h^{(m)}Y′(m, i, j) (18)

where Y′(m, i, j) indicates the binarized pixel values at positions corresponding to the pixel of interest of channel m.

In this case, the input data Xk⁽ⁿ⁾ of the binarizing unit 22 with respect to the pixel X⁽ⁿ⁾ of interest of channel n is expressed by:

Xh⁽ⁿ⁾=X⁽ⁿ⁾+Xe⁽ⁿ⁾+Xh⁽ⁿ⁾−{h⁽¹⁾Y′(1, i, j)+ . . . +h^{(m)}Y′(m, i, j)} (19)

The gain coefficient h can be set for each channel. In order to even out the contributions of respective colors, the gain coefficient h may be set as:

h⁽¹⁾= . . . =h^{(m)} (20)

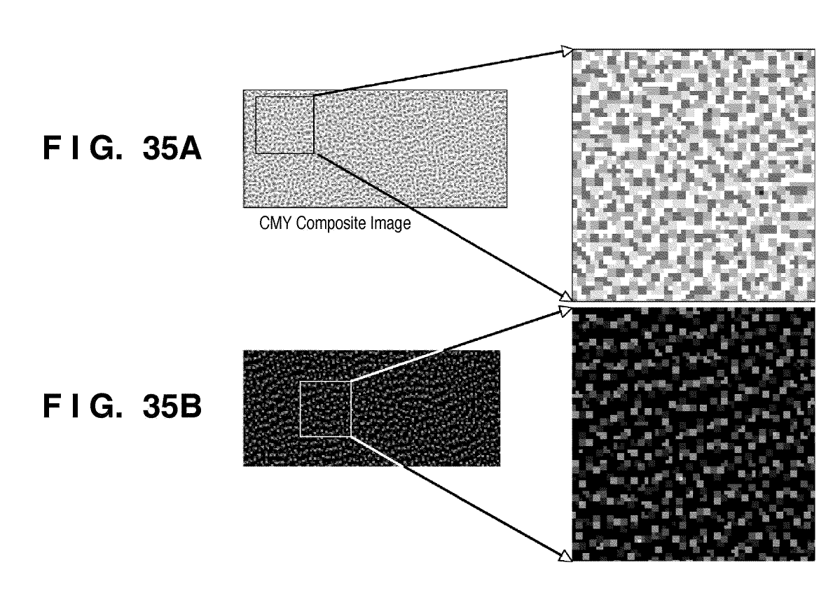

FIGS. 35A and 35B are views showing a composite example of the error diffusion processing results according to the fourth embodiment. FIG. 35A shows dot allocations of three colors, that is, cyan, magenta, and yellow in a highlight region (a tonal value=192). Dots of three colors are exclusively adjacently arranged in a highlight region, and no color heterogeneity due to mixture of dot superimposed and adjacently arranged parts occurs.

FIG. 35B shows dot allocations of three colors, that is, cyan, magenta, and yellow in a shadow region (a tonal value=32). The aforementioned processing is also effective for white dots in a shadow region, and no color heterogeneity due to mixture of dot superimposed and adjacently arranged parts occurs in the shadow region. Note that respective colors form white dots (each having the blackened peripheral part and hollow central part) in the shadow region. Since white dots are expressed as superimposition of two colors in the shadow region, they have a red, green, or blue color, and dots of three colors, that is, red, green, and blue are exclusively adjacently arranged.

### [Combination of Frequency Control and Anisotropy Control]

The avoiding method of color moiré and color heterogeneity by the frequency control has been explained. When this avoiding method is applied to a four-color printer including black, the frequency control and anisotropy control have to be combined so as not to generate any color moiré between colors. For example, the following combinations are available.

In case 1, superimpositions between the spectral distributions of P3, and Q3 and Q4 slightly remain.

Case 1: yellow P1
magenta Q3
cyan Q4
black P3

In case 2, since the three spectra of Q3, Q4, and Q1 (or Q2) are respectively −45°, 45°, and 0° (or 90°), color moiré is hardly generated.

Case 2: yellow P1
magenta Q3
cyan Q4
black Q1 or Q2

In case 3, Q1 and Q2 are the orthogonal spectra along the x- and y-axes, and P4 is the spectrum of ±45°, superimpositions of the spectra are small.

Case 3: yellow P1
magenta Q1
cyan Q2
black P4

Note that the parameters to be assigned to cyan, magenta, and black may be freely determined. However, since magenta and cyan are often set to have the same cluster size, their parameters are preferably selected from the same group. The case to be selected is comprehensively determined together with an optimal clustered dot size based on the modulation transfer function (MTF) characteristic of an image output apparatus.

### [Shift Operation of Feedback Amount]

The feedback amount Xh is calculated by equation (5), and always assumes a positive value.

0≦h×Σᵢ(ai×Yi)≦h×L (21)

where L is a maximum value of image data, which assumes “255” in case of 8-bit data or “1” in case of normalized data.

Since the feedback amount Xh does not assume a negative value, a “suppression” effect does not work. In order to introduce the suppression effect, a shift operation by the second term is required, as given by:

Xh[n]=h×Σᵢ(ai×Yi)−hL/2 (22)

That is, the first term which always assumes a positive value is shifted to the negative side by an amount equivalent to half the range of image data, thus obtaining a feedback amount which nearly evenly assumes a positive or negative value. Therefore, a shift operator is connected to the output side of the gain adjustor 24 shown in FIG. 33 to make a shift operation corresponding to hL/2 in proportion to the gain coefficient h.

A system, which handles 8-bit image data ranging from 0 to 255, executes shift processing by adding −128h to the value of h×Σᵢ(ai×Yi). That is, when the gain coefficient h changes, a shift amount has to be changed accordingly. By shifting the dynamic range in this way, acceleration and suppression of clustering can be attained in a balanced manner.

According to the aforementioned embodiments, pixel data is binarized by the error diffusion processing, a binarization error is distributed to non-binarized pixels, and green-noise data is fed back to the pixel of interest with reference to binarized pixels. In this case, the parameters of the error diffusion processing based on the green-noise method are set for respective colors so as to eliminate overlapping of the spectral distributions of the spatial frequencies of recorded images of different colors. Each parameter includes a combination of an error diffusion matrix, a reference pixel matrix (reference matrix) of binarized pixels, a gain coefficient, and a scan direction. By controlling the combination of the parameter, the spatial frequency and/or anisotropy of recording dots between different colors can be controlled. As a result, color moiré caused in digital halftoning can be eliminated, and a high-quality, clustered FM halftone color image in which color moiré is suppressed can be output.

Furthermore, according to the aforementioned embodiments, dot allocations of highlight and shadow regions after binarization of a color component image before binarization are controlled with reference to a color component image after binarization. As a result, color heterogeneity caused in highlight and shadow regions in digital halftoning can be eliminated, and a high-quality, clustered FM halftone color image in which color heterogeneity is suppressed can be output.

### Exemplary Embodiments

The present invention can be applied to a system constituted by a plurality of devices (e.g., host computer, interface, reader, printer) or to an apparatus comprising a single device (e.g., copying machine, facsimile machine).

Further, the present invention can provide a storage medium storing program code for performing the above-described processes to a computer system or apparatus (e.g., a personal computer), reading the program code, by a CPU or MPU of the computer system or apparatus, from the storage medium, then executing the program.

In this case, the program code read from the storage medium realizes the functions according to the embodiments.

Further, the storage medium, such as a floppy disk, a hard disk, an optical disk, a magneto-optical disk, CD-ROM, CD-R, a magnetic tape, a non-volatile type memory card, and ROM can be used for providing the program code.

Furthermore, besides above-described functions according to the above embodiments can be realized by executing the program code that is read by a computer, the present invention includes a case where an OS (operating system) or the like working on the computer performs a part or entire processes in accordance with designations of the program code and realizes functions according to the above embodiments.

Furthermore, the present invention also includes a case where, after the program code read from the storage medium is written in a function expansion card which is inserted into the computer or in a memory provided in a function expansion unit which is connected to the computer, CPU or the like contained in the function expansion card or unit performs a part or entire process in accordance with designations of the program code and realizes functions of the above embodiments.

In a case where the present invention is applied to the aforementioned storage medium, the storage medium stores program code corresponding to the flowcharts described in the embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-158556, filed Jun. 17, 2008, which is hereby incorporated by reference herein in its entirety.

What is claimed is:

1. A color processing apparatus for quantizing color data having a plurality of color component data to be outputted to an image forming unit, said apparatus comprising:
a first adder, configured to add, to color data of a pixel of interest, first data which is calculated from quantization errors of adjacent pixels of the pixel of interest in accordance with an error diffusion matrix;
a second adder, configured to add, to the color data of the pixel of interest, second data which is calculated from quantization results of the adjacent pixels in accordance with a reference pixel matrix and a gain coefficient;
a quantizing section, configured to quantize the color data of the pixel of interest, to which the first and second data are added; and
a calculator, configured to calculate a quantization error of the pixel of interest from the quantization result,
wherein different combinations of reference pixel matrices and gain coefficients are respectively used for the plurality of color component data.

2. The apparatus according to claim 1, wherein the combinations are set to reduce superimposition of spectral distributions of spatial frequencies of images represented by the plurality of color component data after the quantization.

3. The apparatus according to claim 2, wherein the spatial frequencies of dot patterns of the images represented by the plurality of color component data after the quantization are controlled by the combinations.

4. The apparatus according to claim 1, wherein the combinations are set so that a dot pattern of an image represented by yellow color component data is coarsest compared to dot patterns of images represented by other color component data.

5. The apparatus according to claim 4, wherein an error diffusion matrix corresponding to the yellow color component data has a characteristic of diffusing an error to non-binarized pixels which are separated from the pixel of interest by a predetermined distance, and are located to form a ring pattern.

6. The apparatus according to claim 1, wherein each of the combinations includes the error diffusion matrix, and dot patterns after the quantization of images represented by at least two color component data of cyan, magenta, and black color component data are set to intersect with each other based on combinations of an identical error diffusion matrix, and different reference matrices and gain coefficients.

7. The apparatus according to claim 1, wherein each of the combinations includes a scan direction of the quantization results, and dot patterns after the quantization of images represented by at least two color component data of cyan, magenta, and black color component data are set to intersect with each other based on combinations of different reference matrices and gain coefficients, and two-way scans of the quantization results.

8. The apparatus according to claim 1, wherein each of the combinations includes the error diffusion matrix and a scan direction of the quantization results, and dot patterns after the quantization of images represented by at least two color component data of cyan, magenta, and black color component data are set to intersect with each other based on combinations of an identical quantization matrix, reference matrices and gain coefficients, and forward scans and reverse scans of the quantization results.

9. The apparatus according to claim 1, further comprising a controller configured to control a reference matrix used in processing of color component data of a second color with reference to color component data of a first color after the quantization.

10. A method of quantizing color data having a plurality of color component data, which is carried out in an information processing apparatus, the method comprising the steps of:
adding, to color data of a pixel of interest, first data which is calculated from quantization errors of adjacent pixels of the pixel of interest in accordance with an error diffusion matrix;
adding, to the color data of the pixel of interest, second data which is calculated from quantization results of the adjacent pixels in accordance with a reference pixel matrix and a gain coefficient;
quantizing the color data of the pixel of interest, to which the first and second data are added; and
calculating a quantization error of the pixel of interest from the quantization result,
wherein different combinations of reference pixel matrices and gain coefficients are respectively used for the plurality of color component data.

11. A computer-readable storage medium storing a computer-executable program for causing a computer to perform a color processing method, the method comprising the steps of:
adding, to color data of a pixel of interest, first data which is calculated from quantization errors of adjacent pixels of the pixel of interest in accordance with an error diffusion matrix;
adding, to the color data of the pixel of interest, second data which is calculated from quantization results of the adjacent pixels in accordance with a reference pixel matrix and a gain coefficient;
quantizing the color data of the pixel of interest, to which the first and second data are added; and
calculating a quantization error of the pixel of interest from the quantization result, wherein different combinations of reference pixel matrices and gain coefficients are respectively used for the plurality of color component data.
